(19) United States
(12) Patent Application Publication
(10) Pub. No.: US 2009/0246427 A1
(43) Pub. Date: Oct. 1, 2009

(54) PRODUCT LABELS HAVING REMOVABLE PORTIONS HAVING ADHESIVE AND BACKING THEREON

(76) Inventors: Daniel A. Hincks, Burlington, CT (US); Sarah B. Hincks, Burlington, CT (US)

Correspondence Address: OHLANDT, GREELEY, RUGGIERO & PERLE, LLP, ONE LANDMARK SQUARE, 10TH FLOOR, STAMFORD, CT, 06901, US

(21) Appl. No.: 12/057,536

(22) Filed: Mar. 28, 2008

(51) Int. Cl. B32B 1/02; B32B 33/00; B32B 37/00; B32B 38/10

(52) U.S. Cl. 428/34.1; 156/60; 156/247; 428/41.8

(57) ABSTRACT

A method of labeling a container is provided that includes providing a label having a release liner sheet secured to a label stock sheet; defining a cut line through the release liner sheet but not through the label stock sheet to separate the release liner sheet into a removable portion and a remaining portion; defining a weakened line through the label stock sheet to separate the label stock sheet into a remaining portion and a removable portion; removing the removable portion of the release liner sheet from the label stock sheet so that the remaining portion of the release liner sheet remains secured to the removable portion of the label stock sheet and so that adhesive on the remaining portion of the label stock sheet is exposed; and placing the label on the container so that the exposed adhesive secures the remaining portion of the label stock sheet to the container and so that the remaining portion of the release liner sheet prevents adhesion of the removable portion of the label stock sheet to the container.

### BACKGROUND OF THE INVENTION

1. Field of the Invention

The present disclosure is related to product labels and, more particularly, to product labels that include a removable portion having adhesive covered by a backing, as well as methods of labeling containers having such labels, methods of using such labels, and containers having such labels thereon.

2. Description of Related Art

Most consumer products include a label that identifies the type of product, the manufacturer of the product, and/or other relevant information that is of use to the consumer. Labels have been developed that allow the consumer to remove a portion of the label so that the consumer can maintain certain information from the label, while discarding the container and the remaining portion of the label.

For example, connoisseurs of wine often desire to retain the name, vineyard, and vintage of a particular bottle of wine. Instead of copying the pertinent information from the label or physically removing the entire label from the bottle, labels having a removable portion have been developed.

In another example, some consumer product companies and restaurants run promotional games where products are sold that include a label with a removable game piece. Such game pieces are collected, and when a sufficient number of the correct game pieces are assembled, the consumer is eligible for a prize.

Unfortunately, the prior art detachable labels have not been effective at providing the consumer with the ability to secure the detached portion to a desired location (e.g., a scrapbook, game board, etc).

Accordingly, there is a continuing need for labels having a detachable portion that overcome, mitigate, and/or alleviate the aforementioned and other deleterious effects of prior art labels.

### BRIEF SUMMARY OF THE INVENTION

A method of labeling a container is provided. The method includes the steps of providing a label having a release liner sheet adhesively secured to a label stock sheet; defining a cut line through the release liner sheet but not through the label stock sheet in a first location so that the cut line separates the release liner sheet into a removable portion and a remaining portion; defining a weakened line through the label stock sheet, the second location being substantially co-planar to the first location, the weakened line separating the label stock sheet into a remaining portion and a removable portion; removing the release liner sheet from the label stock sheet so that the remaining portion of the release liner sheet remains adhesively secured to the removable portion of the label stock sheet and so that the removable portion of the release liner sheet is removed from the remaining portion of the label stock sheet to expose adhesive thereon; and placing the label on the container so that the exposed adhesive secures the remaining portion of the label stock sheet to the container and so that the remaining portion of the release liner sheet prevents adhesion of the removable portion of the label stock sheet to the container.

In some embodiments, the removable portion of the label stock sheet having the remaining portion of the release liner sheet adhesively secured thereto is removable from the container by separation of the removable and remaining portions of the label stock sheet along the weakened line. In other embodiments the remaining portion of the label stock sheet is removable from the removable portion of the release liner sheet to expose adhesive thereon so as to allow the removable portion of the label stock sheet to be adhesively secured to a desired location.

A method of collecting desired information from a container in a desired location is also provided. The method includes removing a second portion of a label along a weakened line from a first portion of the label so that the first portion remains adhered to the container, the second portion having a label stock sheet with the desired information thereon and a release liner sheet, the first portion having only the label stock layer; removing the release liner sheet from the label stock layer of the second portion to expose adhesive on the label stock layer of the second portion; and adhering the exposed adhesive on the label stock sheet of the second portion to the desired location.

Further, a label for a container is provided that includes a label stock sheet, a release liner sheet, and an adhesive defined on the label stock sheet. The label stock sheet has a weakened line in a first location to divide the label stock sheet into a removable portion and a remaining portion. The release liner sheet has a cut line in a second location to divide the release liner sheet into a removable portion and a remaining portion. The adhesive removably secures the release liner sheet on the label stock sheet so that the first and second locations are substantially co-planar.

A container is also provided by the present disclosure. The container includes a label adhered to the container, where the label has a detachable portion with an adhesive thereon that is covered by a removable backing. The removable backing prevents the detachable portion from being adhered to the container. The removable backing, when the detachable portion is detached from the label along a weakened line, can be secured to a desired location by removing the backing to expose the adhesive.

The above-described and other features and advantages of the present disclosure will be appreciated and understood by those skilled in the art from the following detailed description, drawings, and appended claims.

### BRIEF DESCRIPTION OF THE SEVERAL VIEWS OF THE DRAWINGS

FIG. 1 is a perspective view of an exemplary embodiment of a label according to the present disclosure, where the label is shown on a container with the removable portion partially removed;

FIG. 2 is a front view of the label of FIG. 1 before removal of the release liner sheet and before application to the container;

FIG. 3 is a rear view of the label of FIG. 2;

FIG. 4 is an end view of the label of FIG. 3;

FIG. 5 is a perspective view of an alternate exemplary embodiment of a label according to the present disclosure;

FIG. 6 is a rear view of the label of FIG. 3 after removal of the release liner sheet and before application to the container;

FIG. 7 is a front view of an exemplary embodiment of a removable portion of the label of FIG. 6 after removal from the label; and

FIG. 8 is an end view of the removable portion of FIG. 7.

### DETAILED DESCRIPTION OF THE INVENTION

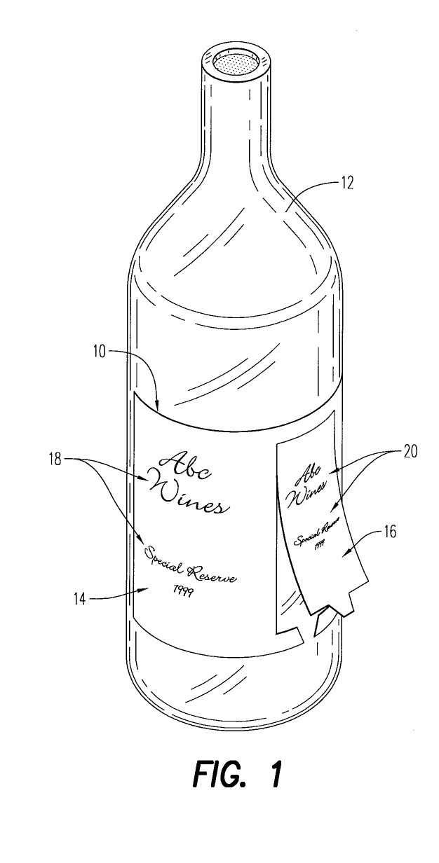

Referring to the drawings and in particular to FIG. 1, an exemplary embodiment of a label according to the present disclosure is shown and generally referred to by reference numeral 10.

Label 10 is illustrated by way of example in use with a container 12, which can be any container such as, but not limited to, a bottle, a can, a cup, a wrapper, a plastic shell, a box, and any other type of packaging.

Label 10 includes a first portion 14 and a second portion 16. Second portion 16 is detachable or removable and, thus, can be detached and removed from container 12 and first portion 14. Moreover, and as will be described in detail below, the second portion 16 includes an adhesive on its rear face so that the second portion can be adhered, after removal from container 12 and first portion 14, to a desired location (not shown). By way of example, the desired location can be a scrapbook, a game board, a coupon book, and any other desired location.

Advantageously, second portion 16, after removal from container 12 and first portion 14, includes a region of release liner sheet or backing covering the adhesive. In this manner, second portion 16 can easily be transported or stored until such time as the second portion is adhered to the desired location. When adhering the second portion 16 to the desired location, the user merely needs to remove the region of release liner sheet to expose the adhesive and apply the second portion to the desired location. In some embodiments, the adhesive can be a releasable adhesive so that that second portion 16 can be repositioned on the desired location after initially being secured thereto.

In the illustrated embodiment, container 12 is shown as a wine bottle. Here, second portion 16 can be transported from a restaurant or vineyard to a consumer's home in their purse, wallet, or pocket with the adhesive protected by the release liner sheet. Once the consumer returns home, the release liner sheet can be removed and the second portion 16 can be applied to a scrapbook of desired or preferred wines.

Accordingly, label 10 includes second portion 16 that functions as a removable sticker so that the second portion 16 can easily be detached from the container 12, transported, and then adhered to a desired location.

Typically, label 10 includes one or more first data 18 recorded on first portion 14 and one or more second data 20 recorded on second portion 16. First and second data 18, 20 can be any desired textual information, any desired visual information, and any combinations thereof.

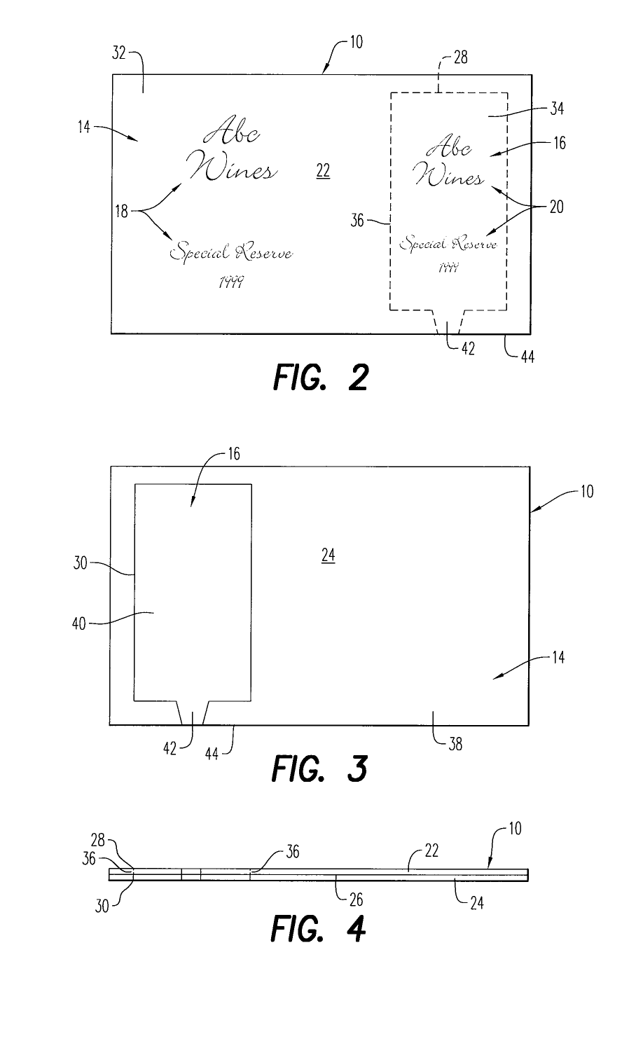

Label 10 and its method of manufacture are described in detail with reference to FIGS. 2 through 4. FIG. 2 illustrates a front view of label 10, FIG. 3 illustrates a rear view of the label, and FIG. 4 illustrates an end view of the label.

Label 10 includes a label stock sheet 22 and a release liner sheet 24. Label stock sheet 22 includes an adhesive 26 thereon in any desired pattern. Release liner sheet 24 covers adhesive 26 in a known manner.

Second portion 16 is defined in label 10 by way of a weakened line 28 and a through cut line 30.

Label stock sheet 22 includes weakened line 28, which divides the label stock sheet into a remaining portion 32 and a removable portion 34. Thus, weakened line 28 detachably secures remaining portion 32 to removable portion 34.

It should also be recognized that second portion 16 is disclosed by way as having a generally rectangular shape. However, it is contemplated by the present disclosure for second portion 16 to have any desired shape including any polygonal shape, shapes having linear edges, shapes having one or more curved edges, and any combinations thereof.

Weakened line 28 can be, for example, a perforation line having a plurality of ties 36, which removably secure remaining portion 32 to removable portion 34. However, it is contemplated by the present disclosure for weakened line 28 to be any line of weakness defined in label stock sheet 22 sufficient to allow the removable and remaining portions 32, 34 of the label stock sheet to be detachably secured to one another.

Release liner sheet 24 includes through cut line 30, which divides the release liner sheet into a removable portion 38 and a remaining portion 40. Cut line 30 ensures that remaining portion 38 is substantially detached from removable portion 40 so that removal of the removable portion from label 10 does not result in removal of the remaining portion from the label.

Accordingly, before use of label 10, cut line 30 separates removable and remaining portions 38, 40 of release liner sheet 24 from one another, while the weakened line 28 detachably secure removable and remaining portions 32, 34 of label stock sheet 22 to one another.

Weakened line 28 and cut line 30 are substantially co-planar to one another. More particularly, weakened line 28 and cut line 30 are substantially normal or perpendicular to a plane defined by the face of label 10. In this manner, the remaining portion 40 of the release liner sheet 24 completely covers the adhesive 26 on the removable portion 34 of the label stock sheet 22.

During manufacture of label 10 and after label stock sheet 22 is adhered to release liner sheet 24, the label stock sheet 22 can be provided with weakened line 28 from the front of the label 10, while release liner sheet 24 can be provided with cut line 30 from the back of the label, which is commonly referred to as a butt-cut line or kiss-cut line.

In another embodiment, after label stock sheet 22 is adhered to release liner sheet 24, both label stock sheet 22 and release liner sheet 24 can be provided with weakened line 28 in the form of a perforation line from either the front or the back of the label 10 leaving ties 36. Then, the temporary weakened line in the release liner sheet 24 can be reworked from the back of the label 10 to remove the ties, converting the temporary weakened line in the release liner sheet 24 to cut line 30.

In some embodiments, second portion 16 can include a lift tab 42. The lift tab 42 extends to at least one outer edge 44 of label 10. In the embodiment illustrated in FIGS. 2-4, label 10 includes lift tab 42 extending to a single outer edge 44. Here, second portion 16 has four sides in common with first portion 14 with the exception of one portion of the side having lift tab 42 so that the second portion is substantially surrounded on all four sides by the first portion.

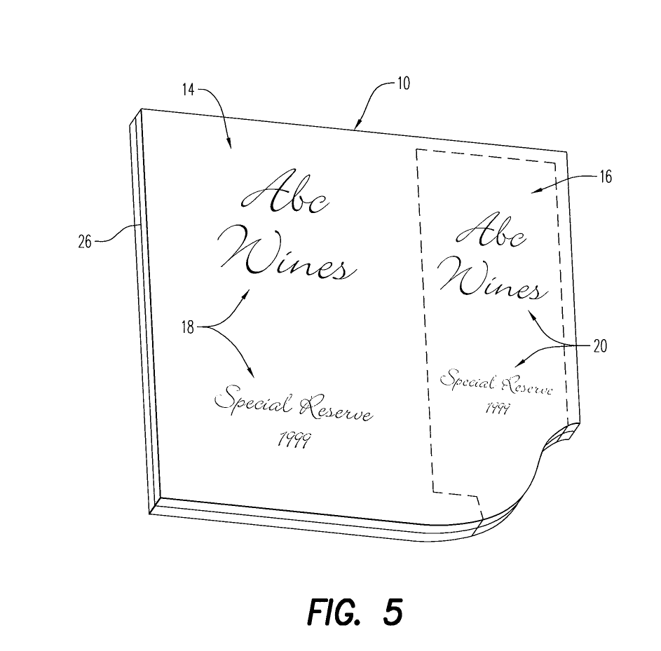

Of course, it is contemplated by the present disclosure for label 10 to be configured so that second portion 16 has as few as one side in common with first portion 14 or as many sides in common as desired. For example, an alternated embodiment of label 10 is shown in FIG. 5. Here, weakened line 28 and cut line 30 define second portion 16 so that the second portion has two complete sides and two partial sides in common with first portion 14.

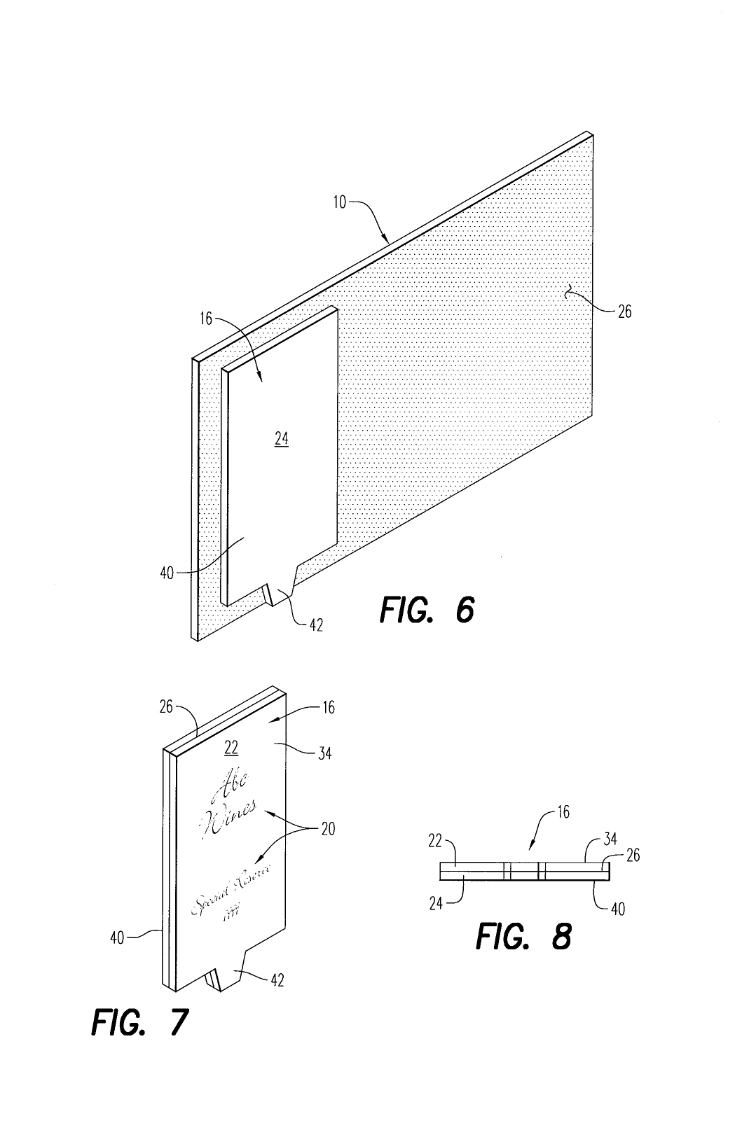

Label 10 and its method of use are further described in detail with reference to FIGS. 6 through 8. FIG. 6 illustrates a rear view of label 10 after removal of removable portion 38 of release liner sheet 24 and before securing the label to container 12. FIG. 7 illustrates a front view of second portion 16 of label 10 after removal from container 12 and first portion 14, while FIG. 8 illustrates an end view of the second portion 16.

When applying label 10 to container 12, the removable portion 38 of release liner sheet 24 is removed from label stock sheet 22 to reveal adhesive 26. Since the release liner sheet 24 includes cut line 30, only the removable portion 38 of the release liner sheet is removed, while the remaining portion 40 of the release liner sheet remains. Thus, first portion 14 of label has the release liner sheet 24 removed therefrom, while the second portion 16 still retains the release liner sheet 24 thereon.

Label 10 is then applied to container 12 so that adhesive 26 secures the label to the container. Since adhesive 26 is revealed only in the region of first portion 14 but not in the region of second portion 16, the adhesive secures only the first portion 14 of label 10 to container. More particularly, remaining portion 40 of release liner sheet 24 prevents removable portion 34 of label stock sheet 22 from adhering to container 12. Here, removal portion 34 is maintained in position on container 12 by virtue of the weakened line 28 detachably securing the removable portion 34 of the label stock sheet 22 to the remaining portion 32 label stock sheet 22.

In order to remove second portion 16 from label 10 and container 12, the user applies a force to the second portion sufficient to tear or otherwise detach the removable portion 32 along the weakened line 28 so that the removable portion 32 of label stock sheet 22 is detached from the remaining portion 34 of the label stock sheet. When present, tab 42 can assist the user in the application of the force to remove second portion 16 from label 10 and container 12.

Once detached, second portion 16 includes removable portion 34 of label stock sheet 22 and remaining portion 40 of release liner sheet 24 with adhesive therebetween as shown in FIG. 8. In this manner, second portion 16 can easily be transported or stored, without adhesive 36 inadvertently securing the second portion to an undesired location or being fouled by dirt or debris. When it is desired to adhere second portion 16 to the desired location, the user merely needs to remove remaining portion 40 of release liner sheet 24 to expose the adhesive 26 on the removable portion 34 of the label stock sheet 22 and apply the second portion to the desired location.

Accordingly, the label 10 of the present disclosure provides a method of labeling a container 12. The method includes the step of providing a release liner sheet 24 adhesively secured to a label stock sheet 22. The method defines a cut line 30 through the release liner sheet 24 but not through the label stock sheet 22 in a first location so that the cut line separates the release liner sheet into the removable portion 38 and the remaining portion 40. The method also defines a weakened line 28 through the label stock sheet 22, the second location being substantially co-planar to the first location, the weakened line separating the label stock sheet into the remaining portion 32 and the removable portion 34.

The method removes the release liner sheet 24 from the label stock sheet 22 so that the remaining portion 40 of the release liner sheet remains adhesively secured to the removable portion 34 of the label stock sheet and so that the removable portion 38 of the release liner sheet is removed from the remaining portion 32 of the label stock sheet to expose adhesive 26 thereon. The method then places the label 10 on the container 12 so that the exposed adhesive 26 secures the remaining portion 32 of the label stock sheet 22 to the container 12 and so that the remaining portion 40 of the release liner sheet 24 prevents adhesion of the removable portion 34 of the label stock sheet to the container.

The removable portion 34 of the label stock sheet 22 having the remaining portion 40 of the release liner sheet 24 adhesively secured thereto is removable from the container 10 by separation of the removable and remaining portions 32, 34 of the label stock sheet along the weakened line 28. The remaining portion 40 of the label stock sheet 22 is removable from the removable portion 34 of the release liner sheet 24 to expose adhesive 26 thereon so that as to allow the removable portion 34 of the label stock sheet 22 to be adhesively secured to a desired location.

Further, the label 10 of the present disclosure also provides a method of collecting desired information from a container 12 in a desired location. The method includes removing a second portion 16 of a label 10 along a weakened line 28 from a first portion 14 of the label so that the first portion 14 remains adhered to the container 12. The second portion 16 has a label stock sheet 22 with the desired information thereon and a release liner sheet 24, the first portion having only the label stock layer.

The method also includes removing the release liner sheet 24 from the label stock layer 22 of the second portion 16 to expose adhesive 26 on the label stock layer 22 of the second portion 16. Then, the exposed adhesive 26 on the label stock sheet 22 of the second portion 16 can be adhered to the desired location.

It should also be noted that the terms “first”, “second”, “third”, “upper”, “lower”, and the like may be used herein to modify various elements. These modifiers do not imply a spatial, sequential, or hierarchical order to the modified elements unless specifically stated.

While the present disclosure has been described with reference to one or more exemplary embodiments, it will be understood that various changes may be made and equivalents may be substituted for elements thereof without departing from the scope of the present disclosure. In addition, many modifications may be made to adapt a particular situation or material to the teachings of the disclosure without departing from the scope thereof. Therefore, it is intended that the present disclosure not be limited to the particular embodiment(s) disclosed as the best mode contemplated, but that the disclosure will include all embodiments falling within the scope of the appended claims.

What is claimed is:

1. A method of labeling a container, comprising:
providing a label having a release liner sheet adhesively secured to a label stock sheet;
defining a cut line through said release liner sheet but not through said label stock sheet in a first location so that said cut line separates said release liner sheet into a removable portion and a remaining portion;
defining a weakened line through said label stock sheet, said second location being substantially co-planar to said first location, said weakened line separating said label stock sheet into a remaining portion and a removable portion;
removing said removable portion of said release liner sheet from said label stock sheet so that said remaining portion of said release liner sheet remains adhesively secured to said removable portion of said label stock sheet and so that adhesive on said remaining portion of said label stock sheet is exposed; and
placing said label on the container so that said exposed adhesive secures said remaining portion of said label stock sheet to the container and so that said remaining portion of said release liner sheet prevents adhesion of said removable portion of said label stock sheet to the container.

2. The label of claim 1, wherein said removable portion of said label stock sheet having said remaining portion of said release liner sheet adhesively secured thereto is removable from the container by separation of said removable and remaining portions of said label stock sheet along said weakened line.

3. The method of claim 2, wherein said remaining portion of said label stock sheet is removable from said removable portion of said release liner sheet to expose adhesive thereon so as to allow said removable portion of said label stock sheet to be adhesively secured to a desired location.

4. The method of claim 1, further comprising including one or more first data recorded on said remaining portion of said release liner sheet and including one or more second data recorded on said removable portion of said release liner sheet.

5. The method of claim 4, wherein said first and second data comprise textual information, visual information, and any combinations thereof.

6. The method of claim 1, wherein said weakened line comprises a perforation line having a plurality of ties.

7. A method of collecting desired information from a container in a desired location, comprising:
removing a second portion of a label along a weakened line from a first portion of said label so that said first portion remains adhered to the container, said second portion having a label stock sheet with said desired information thereon and a release liner sheet, said first portion having only said label stock layer;
removing said release liner sheet from said label stock layer of said second portion to expose adhesive on said label stock layer of said second portion; and
adhering said exposed adhesive on said label stock sheet of said second portion to the desired location.

8. A label for a container, comprising:
a label stock sheet having a weakened line in a first location to divide the label stock sheet into a removable portion and a remaining portion;
a release liner sheet having a cut line in a second location to divide the release liner sheet into a removable portion and a remaining portion; and
an adhesive defined on said label stock sheet, said adhesive removably securing said release liner sheet on said label stock sheet so that said first and second locations are substantially co-planar.

9. The label of claim 8, further comprising one or more first data recorded on said remaining portion of said label stock sheet and one or more second data recorded on said removable portion of said label stock sheet.

10. The label of claim 9, wherein said one or more first data and said one or more second data comprise textual information, visual information, and any combinations thereof.

11. The label of claim 10, wherein the label is a wine bottle label and the container is a wine bottle.

12. The label of claim 9, wherein said removable portion of said label stock sheet and said remaining portion of said release liner sheet define a second label portion.

13. The label of claim 12, wherein said second label portion having a shape selected from the group consisting of a polygonal shape, a shape having linear edges, a shape having curved edges, and any combinations thereof.

14. The label of claim 12, wherein said second label portion further comprises a lift tab extending to at least one outer edge of the label.

15. The label of claim 8, wherein said adhesive is configured to secure said remaining portion of said label stock sheet to the container upon removal of said removable portion of said release liner sheet and said remaining portion of said release liner sheet prevents said adhesive from securing said removable portion of said label stock sheet to the container.

16. The label of claim 15, wherein said removable portion of said label stock sheet having said remaining portion of said release liner sheet secured thereto by said adhesive is removable by separation of said removable and remaining portions of said label stock sheet along said weakened line.

17. The label of claim 16, wherein said remaining portion of said label stock sheet is removable from said removable portion of said release liner sheet to expose adhesive thereon so as to allow said removable portion of said label stock sheet to be adhesively secured to a desired location.

18. The label of claim 8, wherein said weakened line comprises a perforation line having a plurality of ties.

19. A container comprising a label adhered to the container, said label having a detachable portion with an adhesive thereon that is covered by a removable backing such that said detachable portion is not adhered to the container but such that said removable backing, when said detachable portion is detached from said label along a weakened line, covers all of said adhesive, and
wherein said detachable portion, when said detachable portion is detached from said label along said weakened line, can be secured to a desired location by removing said removable backing to expose said adhesive.
